(19) United States
(12) Patent Application Publication
(10) Pub. No.: US 2014/0123945 A1
(43) Pub. Date: May 8, 2014

(54) FUEL DISTRIBUTOR

(71) Applicants: Martin Maier, Moeglingen (DE); Martin Goehner, Vaihingen (DE); Markus Feigl, Markgroeningen (DE); Dietmar Uhlenbrock, Stuttgart (DE); Nikolaus Hautmann, Ditzingen (DE); Holger Uhrig, Memmelsdorf (DE); Helmut Schneider, Aichtal (DE)

(72) Inventors: Martin Maier, Moeglingen (DE); Martin Goehner, Vaihingen (DE); Markus Feigl, Markgroeningen (DE); Dietmar Uhlenbrock, Stuttgart (DE); Nikolaus Hautmann, Ditzingen (DE); Holger Uhrig, Memmelsdorf (DE); Helmut Schneider, Aichtal (DE)

(73) Assignee: ROBERT BOSCH GMBH, Stuttgart (DE)

(21) Appl. No.: 14/115,015

(22) PCT Filed: Mar. 16, 2012
(86) PCT No.: PCT/EP2012/054712

§ 371 Date: Jan. 24, 2014

(30) Foreign Application Priority Data
May 2, 2011 (DE) 102011075061.4

(51) Int. Cl. F02M 69/00

(52) U.S. Cl. CPC F02M 69/00
USPC 123/445; 29/890.09

(57) ABSTRACT

A fuel distributor which is used particularly for fuel injection systems of mixture-compressing, spark ignition internal combustion engines, includes a first half shell and a second half shell. A fuel chamber is embodied between the half shells. A plurality of cups is embodied on the first half shell and/or on the second half shell. The first half shell and the second half shell are connected to each other in a continuous material manner. Such a fuel distributor is especially suitable for medium pressure, particularly between 5 MPa and 7 MPa.

### FIELD OF THE INVENTION

The present invention relates to a fuel distributor which is used particularly for fuel injection systems of mixture-compressing, spark ignition internal combustion engines. The present invention particularly relates to the field of fuel injection systems configured as medium pressure systems.

### BACKGROUND INFORMATION

In fuel injection systems of motor vehicles, it is conceivable that a fuel distributor rail might be used, which would be made of steel for high pressure applications. Through this, a resistance to compression may be achieved of pressures greater than 15 MPa (150 bar). Such a high-pressure rail of steel may be produced as a soldered rail. In this case, a steel pipe is used as the base to which the individual components, especially closure caps, screw-on holder, high-pressure connection and the interfaces to the fuel injector are soldered on. This configuration, however, involves high production costs.

Furthermore, fuel rails may be used for low-pressure applications at 0.3 MPa (3 bar) to 0.5 MPa (5 bar) for applications relating to this topic. The range of applications of such fuel rails for low-pressure applications is, however, limited to this low-pressure area.

### SUMMARY OF THE INVENTION

The fuel distributor according to the present invention, having the features described herein, has the advantage that a fuel distributor suitable for medium pressure is able to be created at comparatively low production costs. The method according to the present invention having the features described herein and the method according to the present invention having the features described herein enable producing a fuel distributor having such an advantage.

The measures mentioned in the dependent claims permit advantageous further developments of the heating device described herein, the fuel injector described herein, and the component of a fuel-injection system described herein.

It is of advantage that the first half shell has a contact area, that the second half shell has a contact area, that the contact area of the first half shell and the contact area of the second half shell face each other and that the first half shell and the second half shell are connected to each other in a continuous material fashion by soldering, using soldering applied between the contact area of the first half shell and the contact area of the second half shell. In this connection, it is also advantageous that the first half shell and the second half shell are connected to each other in a continuous material fashion by soldering, using soldering foil applied between the contact area of the first half shell and the contact area of the second half shell. The two contact areas of the half shells may be executed to be planar, so that an advantageous contact surface comes about for developing the solder connection. In this context, this contact surface may also encompass certain areas which are provided in the area of cups, for example. In addition, the contact surface may thereby be configured to be relatively large. The two half shells positioned towards each other, having the soldering foil positioned in between, may be soldered together by a soldering oven, which is able to be configured as a continuous-heating furnace. In this way, there comes about a cost-effective production, within the scope of mass production.

It is, however, also advantageous that an edge of the first half shell and an edge of the second half shell are configured, at least in sections, to lie next to each other, and that the first half shell and the second half shell are connected to each other in a continuous material fashion by a welding seam running in the circumferential direction along the edge of the first half shell and the edge of the second half shell. In the initial state, the two half shells may advantageously be formed by sheet metal halves, which are welded together at their edge. Subsequently, in an advantageous manner, inflating the sheet metal halves into the half shells may take place by hydroforming. In order to produce the final geometry, magnetic forming is also a possibility.

It is advantageous that the cups are embodied by deep drawing of the first half shell and the second half shell. The cups are advantageously embodied on the half shells, the cups may be embodied on one of the half shells. This makes separate soldering on, welding on or comparable mounting of the cups on the half shells unnecessary, so that method steps in this regard may be saved. In addition, with reference to the range of application of medium pressure, an embodiment of the half shells may take place of a material that makes possible the configuration of the cups by deep drawing on at least one of the half shells. Because of this, the production costs may be further reduced.

It is also advantageous that a connecting socket is provided that leads into the fuel chamber and that the first half shell and/or the second half shell have at least one part formed to shape a into which the connecting socket may be placed.

Therefore, the connecting socket may advantageously be used between the half shells, it being possible, for example, during the embodiment of a soldering connection between the half shells, to solder the connecting socket at the same time into the half shells in the vicinity of the part formed to shape.

It is also advantageous that at least one fixing strap is connected in an attached form on the first half shell and/or the second half shell. For the indicated range of application of medium pressure, in turn, in this instance, the suitably effective configuration of the fixing strap. Moreover, it is also possible that further parts formed to shape are provided on the half shells which are able to be produced cost-effectively. One example of such formations are beads which improve the stability of the shape.

It is also advantageous that, between the cups and the fuel compartment, a connecting channel is provided in each case, which is embodied by embossing on the first half shell and/or by embossing on the second half shell. By doing this, a connecting channel, which may be short, may be embodied between the cups and the fuel compartment, so that altogether an optimized embodiment of the fuel distributor comes about, in particular, having a compact configuration and great stability.

Depending upon the application, the cups may advantageously be reworked. In this instance, it is advantageous that the floor of the cups is removed by metal cutting work. It is also advantageous that the cups are configured as countersunk or embossed cups. Thereby the assembly of the fuel injectors on the cups may be simplified. Furthermore, the connection of the fuel injectors to the cups may be improved by advantageously reworking the inside walls of the cups by metal cutting work. In this instance, honing is particularly suitable for improving the surface quality.

Exemplary embodiments of the present invention are explained in greater detail in the following description with reference to the attached drawings, in which identical elements have been provided with matching reference numerals.

### BRIEF DESCRIPTION OF THE DRAWINGS

FIG. 1 shows a fuel distributor in a schematic representation, corresponding to an exemplary embodiment of the present invention.

FIG. 2 shows the fuel distributor shown in FIG. 1, from the direction of view denoted by II, corresponding to the exemplary embodiment of the present invention.

FIG. 3 shows a schematic section through the fuel distributor shown in FIG. 1, along the sectional line denoted by III, corresponding to the exemplary embodiment of the present invention.

### DETAILED DESCRIPTION

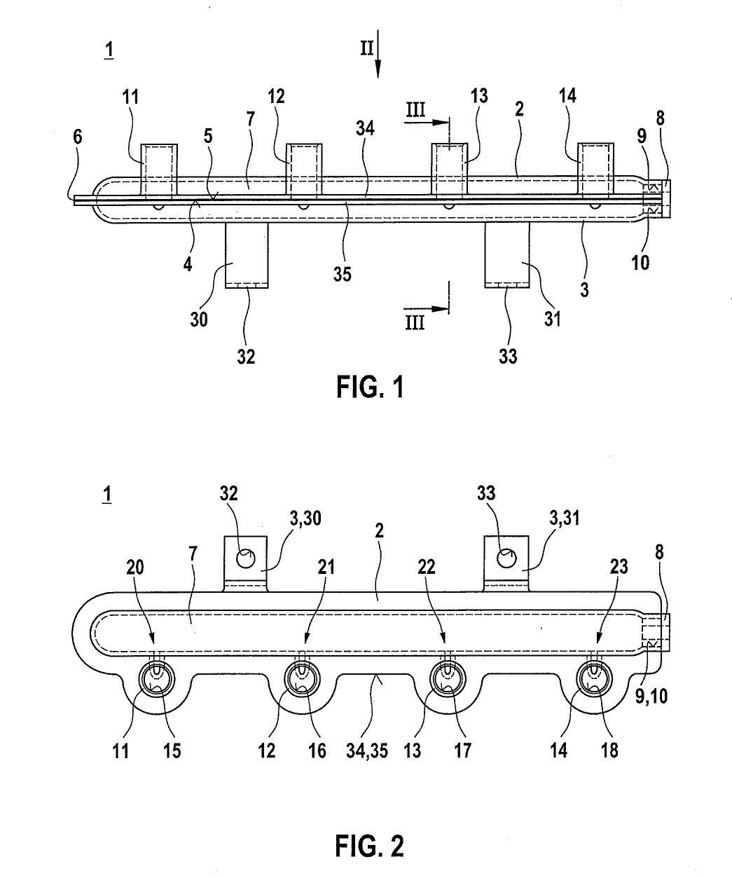

FIG. 1 shows an exemplary embodiment of a fuel distributor 1 of the present invention in a schematic representation. Fuel distributor 1 may particularly be embodied in the form of a common rail 1. Fuel distributor 1 is particularly suited for fuel-injection systems of mixture-compressing internal combustion engines having spark ignition. Fuel distributor 1 is particularly suitable for a medium pressure system, in this case. The medium pressure for such a medium pressure system, in this case, may be in the range of 3 MPa to 10 MPa, or 30 bar to 100 bar. In particular, the medium pressure may be in the range of 5 MPa to 7 MPa, or 50 bar to 70 bar. However, fuel distributor 1 is also suitable for other applications.

Fuel distributor 1 has a first half shell 2 and a second half shell 3. First half shell 2 has a contact area 4. Furthermore, second half shell 3 has a contact area 5. Contact areas 4, 5 of half shells 2, 3 face each other. During production of fuel distributor 1, a soldering foil 6 is inserted between contact areas 4, 5. The two half shells 2, 3 are then soldered together using a soldering furnace. This ensures a connection in continuous material.

A fuel chamber 7 is embodied between the two half shells 2, 3, which is illustrated by a broken line 7. Fuel chamber 7 is embodied as an elongated fuel chamber 7, in this exemplary embodiment. In this instance, fuel chamber 7 has the function of a storage volume 7. Fuel chamber 7 is formed by the two half shells 2, 3 in common.

The two half shells 2, 3 may be formed, for instance, as stamped and/or bent parts made of alloyed steel. A connecting socket 8 is additionally situated between the two half shells 2, 3. Connecting socket 8 acts in this case as a hydraulic connection 8, to connect a fuel line to fuel distributor 1. The fuel may thereby be guided from the connected fuel line into fuel chamber 7. In this instance, the fuel may have a medium pressure from the abovementioned medium pressure range. Connecting socket 8 may particularly be configured as a threaded socket 8. Connecting socket 8 may be developed, for example, as a turned part. Connecting socket 8 may be formed of an alloyed steel. To accommodate connecting socket 8, half shells 2, 3 each have a part formed to shape 9, 10 which in the assembled state of half shells 2, 3 form, for instance, a cylinder-shaped accommodation 9, 10 for connecting socket 8. Connecting socket 8 may be soldered into parts formed to shape 9, 10.

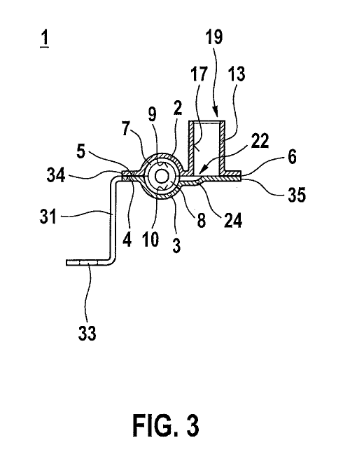

Fuel distributor 1 is further described below, and also with reference to FIGS. 2 and 3.

FIG. 2 shows fuel distributor 1 shown in FIG. 1, direction of view denoted by II. FIG. 3 shows fuel distributor 1 shown in FIG. 1 in a schematic sectional representation along the sectional line denoted by III. On the first half shell 2, cups 11, 12, 13, 14 are embodied. The embodiment of cups 11 through 14 may be made by deep drawing. Inner walls 15, 16, 17, 18 of cups 11 to 14 may be reworked, especially by a metal cutting operation, such as honing. The surface of walls 15 to 18 may be improved thereby. The surface quality of inner walls 15 to 18 of cups 11 to 14 may be improved thereby, especially with reference to a required sealing. Because of surface scratches, for example, the surface quality may be impaired and consequently, so may a possible sealing effect. Such surface scratches may then be smoothed out by the metal cutting work. A floor of deep drawn cups 11 to 14 may also be taken down by a metal cutting operation. For the reliable introduction of the fuel injectors, especially when using an O-ring, cups 11 to 14 may be countersunk or embossed. Such countersinking 19 or embossing 19 is shown in exemplary fashion on cup 13 in FIG. 3.

Between cups 11 to 14 and fuel chamber 7 a connecting channel 20, 21, 22, 23 is provided in each case. During operation, via connecting channels 20 to 23, fuel gets from fuel chamber 7 into cups 11 to 14, on which the fuel injectors are mounted. Consequently, the fuel under medium pressure is able to be supplied to the fuel injectors.

As shown in FIG. 3, connecting channel 22 between fuel chamber 7 and cup 13, in this exemplary embodiment, is embodied by an embossing 24 on second half shell 3. In addition or alternatively, connecting channels 22 may also be embodied by an embossing on first half shell and the second half shell 2 The embodiment of connecting channels 20, 21, 23 is able to take place in a corresponding manner.

In this exemplary embodiment, fixing straps 30, 31 are connected in an attached form to second half shell 3. Bores 32, 33 are provided on fixing straps 30, 31. Because of this, fuel distributor 1 may be mounted, for example, in the engine compartment on an internal combustion engine. In addition or alternatively, such fixing straps may also be connected in an attached form to first half shell 2.

The material thickness of half shells 2, 3 is a function of the desired durability or resistance to fatigue. In this instance, beads or the like may be worked into half shells 2, 3, in order to improve the inherent stability.

Connecting socket 8 may be formed of an alloyed steel, for example. In this exemplary embodiment, connecting socket 8 is located in the part formed to shape 9, 10 of the two half shells 2, 3 formed by parts formed to shape 9, 10. Other possibilities are also conceivable, however, for fastening such a connecting socket 8 on half shells 2, 3.

To fix the two half shells 2, 3 during production, at least three joining aids may be embossed on half shells 2, 3. These joining aids are comparable to TOX clinching. Such joining aids, however, need not be embossed in the joined state of half shells 2, 3 but during the general shaping work. The diameters selected and tolerances of this joining aid ensure that, during the soldering process, the two half shells 2, 3 remain in position.

During the production of fuel distributor 1, first half shell and the second half shell 2 may be inserted into the receptacle of a press. Then, soldering foil 6, secured by the joining aids, may be placed on first half shell and the second half shell 2. Connecting socket 8 is joined into part formed to shape 9 and also surrounded by soldering foil. Second half shell 3 is then mounted on, the fixing taking place via the joining aids. The press is triggered and presses the two half shells 2, 3 together. Fuel distributor 1 is then removed from the press and placed on the conveyor belt of the soldering oven.

After the soldering step, the floor of deep drawn cups 11 to 14 is removed by metal cutting. For the reliable introduction of the fuel injectors, cups 11 to 14 are undercut or embossed, so that undercutting or embossing 19 is embodied. If the surface quality of inner walls 15 to 18 of cups 11 to 14 is not sufficient to provide seals, suitable reworking may take place, for instance by honing. After visual inspection and the testing of the seals, fuel distributor 1 may be delivered.

Fuel distributor 1 may also be produced in another way. In that case, sheet metal halves may be used as starting material, which are welded together at their edges 34, 35. The two sheet metal halves 2, 3 are thereby joined in such a way that contact areas 4, 5 face each other and edges 34, 35 are situated lying next to each other. Because of this, a welding seam may be embodied circumferentially along the edges 34, 35 that lie next to each other. Subsequently, the final geometry of sheet metal halves 2, 3 may be produced by hydroforming or by magnetic forming.

In this case, as starting material, two stamped sheet metal halves 2, 3, matching in circumference, are welded all around at their circumference. During hydroforming, a fluid is pressed in under high pressure between the two sheet metal halves 2, 3, so that sheet metal halves 2, 3 that are connected to each other blow out until a tube-like geometry is created. The half shells 2, 3 are embodied in this way from the sheet metal halves 2, 3 by the hydroforming.

In a corresponding manner, during magnetic forming, the sheet metal halves 2, 3 are embodied in their final geometry.

The present invention is not limited to the exemplary embodiments described.

1-13. (canceled)

14. A fuel distributor for a fuel injection system of a mixture-compressing, spark ignition internal combustion engine, comprising:
a first half shell; and
a second half shell, between which a fuel chamber is embodied;
wherein on at least one of the first half shell and the second half shell, there is a plurality of cups, and
wherein the first half shell and the second half shell are connected to each other in a continuous material manner.

15. The fuel distributor of claim 14, wherein:
the first half shell has a contact area,
the second half shell has a contact area,
the contact area of the first half shell and the second half shell and the contact area of the second half shell face each other, and
the first half shell and the second half shell are connected to each other in a continuous material manner by solder using a soldering arrangement inserted between the contact area of the first half shell and the contact area of the second half shell.

16. The fuel distributor of claim 15, wherein the first half shell and the second half shell are connected to each other in a continuous material manner by soldering, using a soldering foil inserted between the contact area of the first half shell and the contact area of the second half shell.

17. The fuel distributor of claim 14, wherein an edge of the first half shell and an edge of the second half shell are configured, at least in sections, to lie next to each other, and wherein the first half shell and the second half shell are connected to each other in a continuous material manner by a welding seam running in the circumferential direction along the edge of the first half shell and the edge of the second half shell.

18. The fuel distributor of claim 14, wherein the cups are embodied by deep drawing of the first half shell and the second half shell, respectively.

19. The fuel distributor of claim 14, wherein a connecting socket leads into the fuel chamber, and wherein at least one of the first half shell and the second half shell have at least one part formed to shape into which the connecting socket is placeable.

20. The fuel distributor of claim 14, wherein at least one fixing strap is connected in an attached form on at least one of the first half shell and the second half shell.

21. The fuel distributor of claim 20, wherein respectively there is one connecting channel between the cups and the fuel chamber, which is embodied by at least one of an embossing on the first half shell and an embossing on the second half-shell.

22. The fuel distributor of claim 14, wherein a floor of the cups is removed by metal cutting work.

23. The fuel distributor of claim 14, wherein at least one of the following is satisfied:
(i) the cups are embodied as undercut or embossed cups, and (ii) the inner walls of the cups are reworked by metal cutting work.

24. A method for producing a fuel distributor, which is for a fuel injection system of a mixture-compressing, spark ignition internal combustion engine, the method comprising:
inserting a soldering foil between a contact area of a first half shell and a contact area of a second half shell, the contact area of the first half shell and the contact area of the second half shell facing each other;
pressing together the first half shell and the second half shell; and
soldering the first half shell to the second half shell using a soldering furnace.

25. A method for producing a fuel distributor, which is for a fuel injection system of a mixture-compressing, spark ignition internal combustion engine, the method comprising:
assembling a first sheet metal half and a second sheet metal half, so that an edge of the first sheet metal half and an edge of the second sheet metal half lie next to each other, at least in sections;
welding the first sheet metal half to the second sheet metal half circumferentially along the edge of the first sheet metal half and the edge of the second sheet metal half; and
reforming the sheet metal halves that are welded to each other to form a first half shell from the first sheet metal half and a second half shell from the second sheet metal half, the half shells being welded to each other.

26. The method of claim 25, wherein the sheet metal halves that are welded to each other are reformed by inserting a fluid under high pressure between the sheet metal halves or by magnetic forming.
